(19) United States
(12) Patent Application Publication
(10) Pub. No.: US 2009/0001205 A1
(43) Pub. Date: Jan. 1, 2009

(54) CUTTER DEVICE FOR A CRUSHING MACHINE

(76) Inventor: Yu-Chun CHANG, Fongyuan City (TW)

Correspondence Address: SINORICA, LLC, 528 FALLSGROVE DRIVE, ROCKVILLE, MD, 20850, US

(21) Appl. No.: 11/768,285

(22) Filed: Jun. 26, 2007

(51) Int. Cl. B02C 4/30

(52) U.S. Cl. 241/291; 241/260

(57) ABSTRACT

A cutter device for a crushing machine includes a main body and plural cutter bodies. The main body is composed of plural rollers arranged continuously together. Each roller has its diametrical circumference formed with at least one flat cut surface formed integral with a cutter base with a fixing hole. Each roller has its diametrical circumferential side provided with a rib, and each cutter body has its cutting side disposed with four curved blade edges extending toward the center to form a projection, letting the cross section of the cutter body formed with a double-curved surface and thus thickening the cutter body and prolonging its service life. The cutter body can be secured on the cutter base by a fastener, convenient in disassembling and replacing the cutter bodies with new ones.

### BACKGROUND OF THE INVENTION

1. Field of the Invention

This invention relates to a cutter device for a crushing machine, particularly to one used for crushing wood chips or plastic materials.

2. Description of the Prior Art

The cutter device of a conventional crushing machine, as shown in FIGS. 1 and 2, includes a main body 10 and p plurality of cutter bodies 20. The main body 10 is composed of plural rollers 11 continuously arranged together and respectively having its diametrical circumferential side formed with curved ribs 12 axially connected together and respectively formed with a triangular cross section. The ribs 12 are respectively provided with at least one recess 121 to be filled with filler for welding and fixing a cutter base 13 thereon. Each cutter body 20 has its topside disposed with four blade edges 21 respectively formed with a downward-curved edge 221 and its center bored with a combining hole 22, with the topside of the cutter body 20 slanting downward toward the combining hole 22. The cutter body 20 is secured on the cutter base 13 by means of a fastener inserted through the combining hole 22 for facilitating disassembling and replacing the cutter body 20. Although the curved edges 211 of the cutter bodies 20 can carry out cutting a large quantity of wood chips, yet the cutter bodies 20 are thin and fragile, easy to be damaged and necessary to be replaced with new ones regularly. In addition, the ribs 12 are arch-shaped, so they are unable to carry a large amount of wood chips, and the cutter bases 13 must be accurately and respectively aligned to the recesses 121 and disposed at a proper location and then firmly secured in the recess 121 by sintering and welding with filler, thus lowering manufacturing accuracy and likely to make the main body 10 deformed during sintering and welding.

### SUMMARY OF THE INVENTION

The objective of this invention is to offer a cutter device for a crushing machine, which includes a main body and a plurality of cutter bodies. The main body is composed of plural rollers arranged continuously together, and each roller has its diametrical circumference formed with at least one flat cut surface having its central portion formed integral with a cutter base protruding diametrically to divide the flat cut surface into a first flat cut member and a second flat cut member. The cutter base is bored with a fixing hole, and each roller has its diametrical circumference provided with a rib. Each cutter body is secured at one sidewall of the cutter base and formed with a cutting side and a cutter back. The cutting side of each cutter body is disposed with at least four blade edges respectively extending toward the center of the cutter body, where a projection is formed, letting the cross section of the cutter body formed with a double-curved surface. The cutter back of the cutter body is bored with a combining hole for a fastener to be inserted therethrough from the rear side of the cutter base and firmly fit in the combining hole of the cutter back to fix the cutter body on the cutter base.

Specifically, the cutter device of this invention has the four blade edges of each cutter body extending toward the center where is formed with a projection so as to thicken the cutter body and prolong its service life, able to reduce equipment cost. In addition, the rib members are respectively formed with curved cross section, and the flat cut surface of each roller has its opposite sides respectively disposed with the first and the second flat cut member, which are helpful to carry a large amount of wood chips. Moreover, Each cutting side of the cutter body has its cross section formed with a double-curved surface for throwing out wood chips easily and speeding up collecting of wood dust, and the cutter base is integrally formed on the roller, so the cutter body can be formed and positioned with great accuracy and can avoid being deformed, thus saving time in making and assembling the cutter bases and conducive to securing the cutter bodies on the cutter bases.

### BRIEF DESCRIPTION OF DRAWINGS

This invention will be better understood by referring to the accompanying drawings, wherein:

FIG. 1 is a cross-sectional view of the cutter device of a conventional crushing machine:

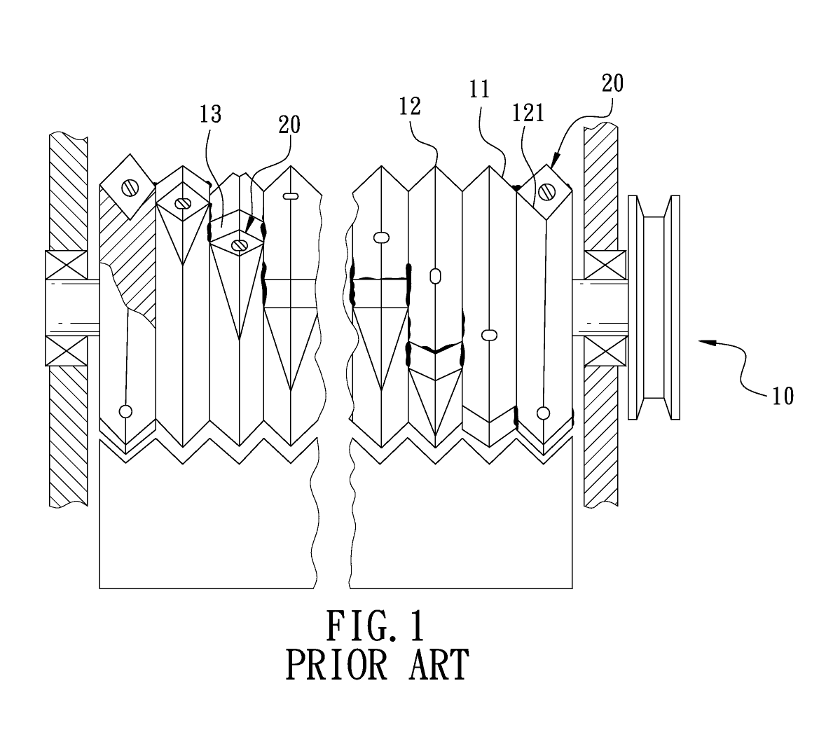

FIG. 2 is a perspective view of a cutter body of the conventional crushing machine;

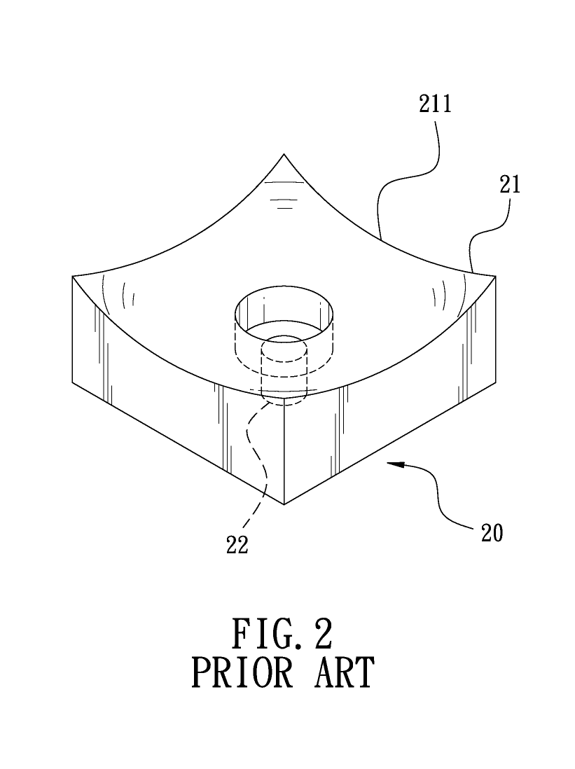

FIG. 3 is a cross-sectional view of the cutter device of a crushing machine in the present invention;

FIG. 4 is another cross-sectional view of the cutter device of the crushing machine in the present invention;

FIG. 5 is a perspective view of a cutter body of the cutter device of the crushing machine in the present invention;

FIG. 6 is a cross-sectional view of the line A-A in FIG. 5;

FIG. 7 is a cross-sectional view of the line B-B in FIG. 5; and

FIG. 8 is a side cross-sectional view of the cutter device of the crushing machine in a using condition in the present invention.

### DETAILED DESCRIPTION OF THE PREFERRED EMBODIMENT

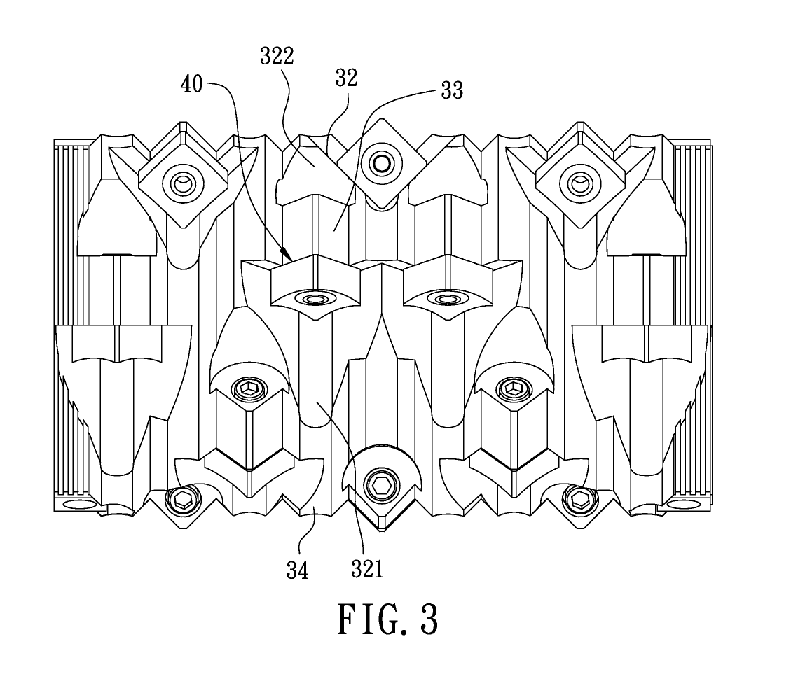

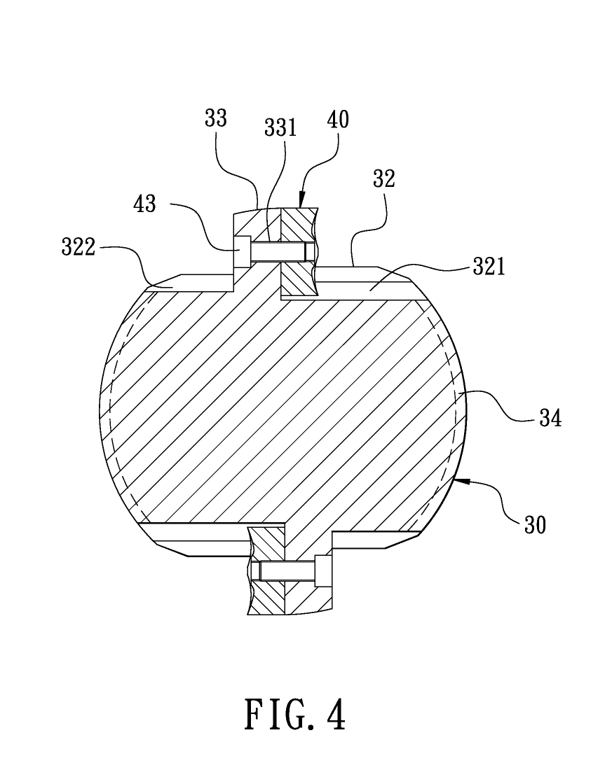

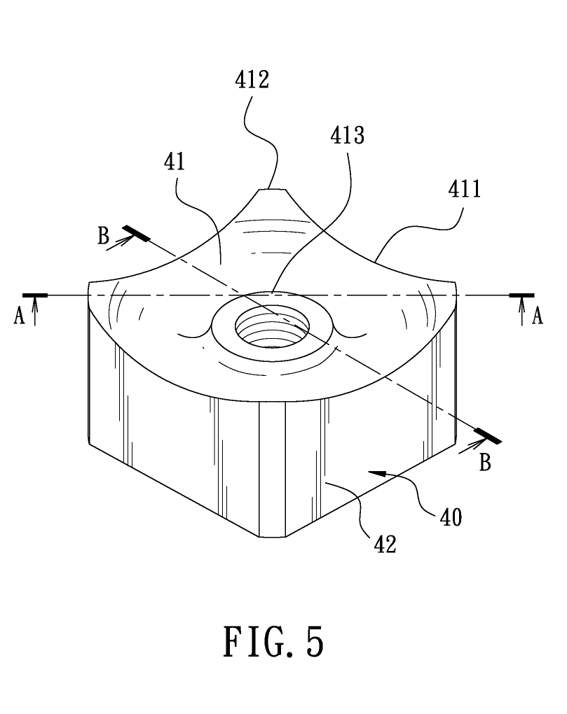

A preferred embodiment of a cutter device for a crushing machine in the present invention, as shown in FIGS. 3 to 8, includes a main body 30 and a plurality of cutter bodies 40 combined together.

The main body is composed of plural rollers 31 formed integral and axially arranged continuously together, and each roller 31 has its diametrical circumference formed with two flat cut surfaces 32. The flat cut surfaces 32 of the rollers 31 are distributed unevenly with one another and extended to the abutting roller 31, respectively having its central portion diametrically extending outward to form integrally a cutter base 33, letting the opposite sides of the flat cut surface 22 respectively divided into a first cut member 321 and a second flat cut member 322. The cutter base 33 is bored with a fixing hole 331 in the center, and each roller 31 has its diametrical circumference provided with an M-shaped rib 34 with a curved cross section.

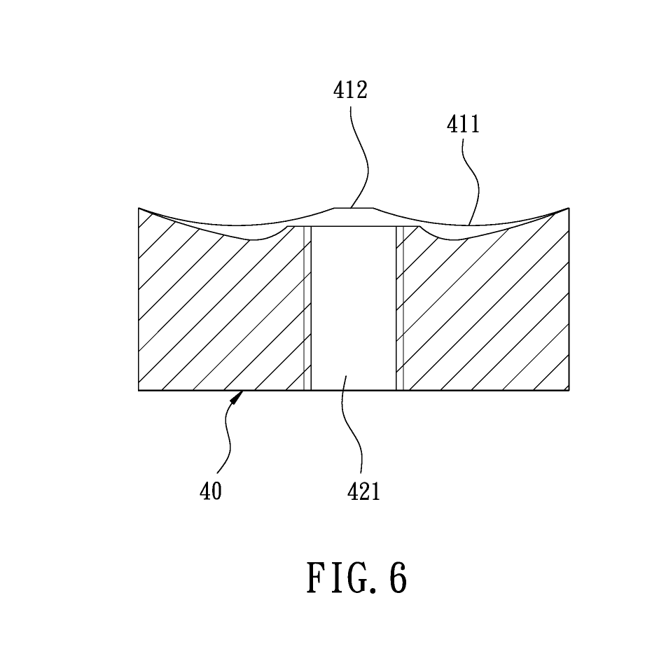

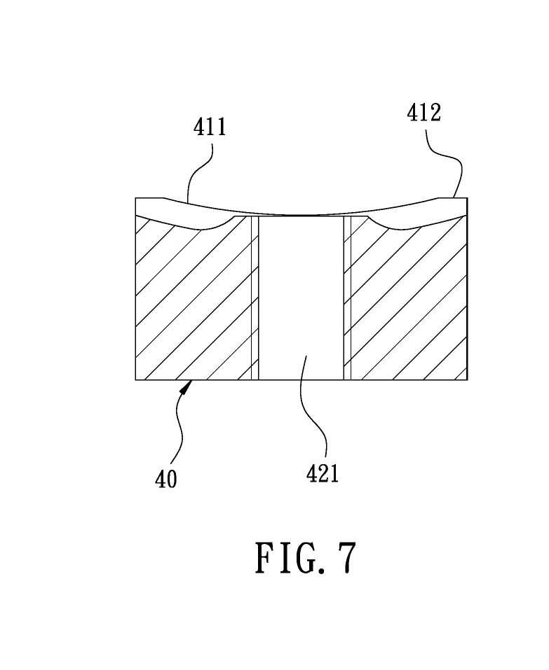

The cutter bodies 40 are respectively fixed at one side wall of the cutter base 33, and each cutter body 40 is formed with a cutting side 41 and a cutter back 42. The cutting side 41 of the cutter body 40 is provided with at least four curved blade edges 411 and the corner of each blade edge 411 is formed with a chamfer 412. Further, the four blade edges 411 are respectively extend toward the center of the cutter body 40, where is formed with a projection 413, letting the cross section of the cutting side 41 formed with a double-curved surface, as shown in FIGS. 6 and 7. Furthermore, the cutter back 42 of the cutter body 40 is bored with a combining hole 421, and a fastener 43 is inserted through the fixing hole 331 from the other sidewall of the cutter base 33 and firmly fiting in the combining hole 421 of the cutter back 42.

Specifically, the main body 30 of the cutter device is made of a plurality of rollers 31 formed integral, and each roller 31 provided with the flat cut surfaces 32 preset in number and respectively having a central portion formed integral with the cutter base 33 protruding diametrically, which will never be deformed. The opposite sides of the flat cut surface 32 and the cutter base 33 are respectively reserved with the first flat cut member 321 and the second flat cut member 322, and each roller 31 has its diametrical circumferential side disposed with an M-shaped rib 34 with a curved cross section. The cutter back 42 of each cutter body 40 is bored with the combining hole 421 and the fastener 43 is diametrically inserted through the fixing hole 331 from the rear side wall of the cutter base 33 and firmly fitting in the combining hole 421 of the cutter back 42 for firmly fixing the cutter body 40 on the cutter base 33 at the central portion of the flat cutting surface 32, thus finishing assembly of the cutter device.

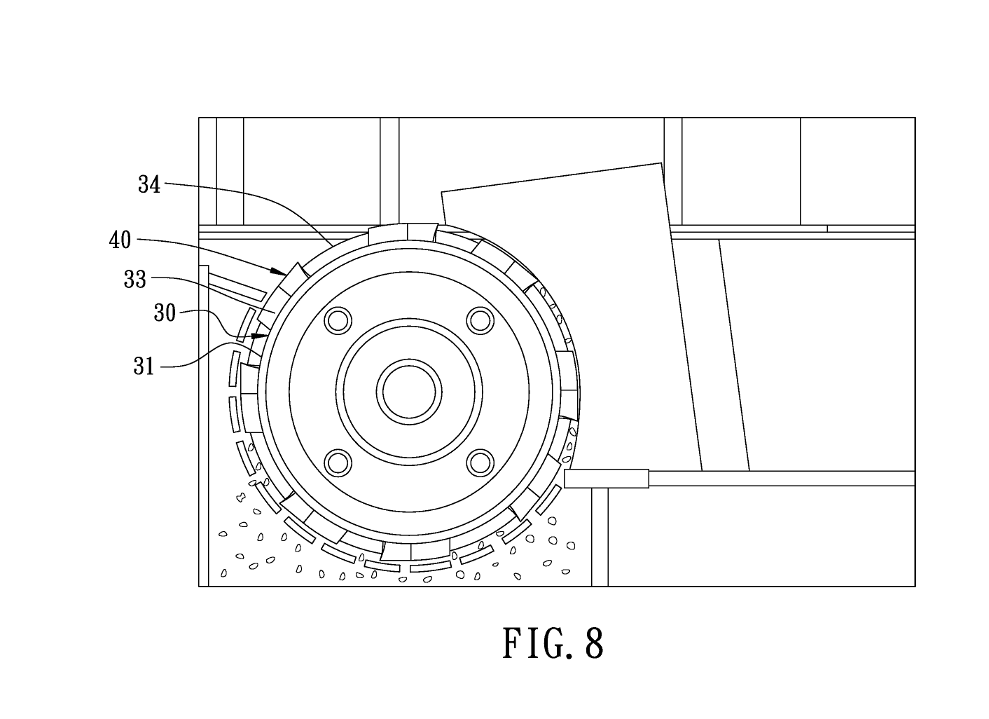

In using, as shown in FIG. 8, when the crushing machine is started to drive the main body 30 and the rollers 31 of the cutter device to rotate, the cutter bodies 40 unevenly distributed on the main body 30 will be actuated to rotate and carry out cutting along the diametrical circumference of the main body 30. Simultaneously, a large quantity of wood chips carried by the ribs 34 and the first flat cut member 321 and the second flat cutting member 322 will be quickly crushed and conveyed to a dust-collecting box (not shown) to be collected.

As can be understood from the above description, this invention has the following advantages.

1. Each cutter body of this invention has its four blade edges extending toward the center of the cutter body to form a projection for increasing the thickness of the cutter body and prolonging its service life. Further, each rib member has its circumference formed with a curved cross section, able to reduce equipment cost, and each flat cut surface on the roller is provided with the first and the second flat cut member, conducive to carrying a large amount of wood chips. Furthermore, the cross section of the cutting side of the cutter body is formed with a double-curved surface for facilitating throwing out wood dust, able to speed up collecting of wood dust and crushing of wood chips.

2. The cutter bases of this invention are integrally formed on the rollers, so the cutter bases can be made and positioned with great accuracy and will not be deformed, thus saving time in producing the cutter bases and facilitating the cutter body to be secured on the cutter base.

While the preferred embodiment of the invention has been described above, it will be recognized and understood that various modifications may be made therein and the appended claims are intended to cover all such modifications that may fall within the spirit and scope of the invention.

I claim:

1. A cutter device for a crushing machine comprising:
A main body composed of a plurality of rollers continuously arranged together, each of said plural rollers having its diametrical circumferential side formed with one flat cut surface, said flat cut surface formed integral with a projecting cutter base, said flat cut surface divided into a first flat cut member and a second flat cut member, said cutter base bored with a fixing hole, each said roller having it s diametrical circumference disposed with a rib; and
a plurality of cutter bodies respectively assembled on one side wall of said cutter base, each said cutter body formed with a cutting side and a cutter back, said cutting side of said cutter body provided with at least four curved blade edges, said four blade edges of said cutter body extending toward a center of said cutter body and formed with a projection, said cutter body having a cross section formed with a double-curved surface, said cutter back bored with a combining hole.

2. The cutter device for a crushing machine as claimed in claim 1, wherein said rollers are formed integral and axially disposed incessantly.

3. The cutter device for a crushing machine as claimed in claim 1, wherein said flat cut surface on said rollers of said main body is distributed in parallel from each other.

4. The cutter device fro a crushing machine as claimed in claim 1, wherein said flat cut surface on all said rollers of said main body is distributed not in parallel from each other.

5. The cutter device for a crushing machine as claimed in claim 1, wherein a diametrical circumference of each said rib is formed with an M-shaped curved cross section.

6. The cutter device for a crushing machine as claimed in claim 1, wherein the diametrical circumference of each said rib formed with a trapezoid cross section.

7. The cutter device for crushing machine as claimed in claim 1, wherein said flat cut surface of one of said rollers extends to that of adjacent one of said rollers.
